(19) United States
(12) Patent Application Publication
(10) Pub. No.: US 2015/0320006 A1
(43) Pub. Date: Nov. 12, 2015

(54) SYSTEM AND METHOD FOR REMOVING DISINFECTANT SOLUTION FROM UDDERS AND TEATS OF COWS

(71) Applicant: Alpha Technology U.S.A. Corporation, Longwood, FL (US)

(72) Inventors: Kevin Dole, Longwood, FL (US); Larry Bilskie, Winter Springs, FL (US)

(21) Appl. No.: 14/705,475

(22) Filed: May 6, 2015

Related U.S. Application Data
(60) Provisional application No. 61/989,131, filed on May 6, 2014.

(51) Int. Cl. A01J 7/04; A01K 13/00

(52) U.S. Cl. CPC A01J 7/04; A01K 13/001

(57) ABSTRACT

Embodiments described herein pertain to a system and method for removing disinfectant solution from teats or one or more. The system includes a fluid or air flow generator having at least one fluid flow outlet positioned relative to one or more cows to supply fluid flow across teats of the one or more cows after a disinfectant solution has been applied to the teats. In addition there is relative lateral movement between the teats and the at least one fluid flow outlet to remove disinfectant solution from the teats or dry the teats.

### CROSS-REFERENCE TO RELATED APPLICATIONS

This application claims the benefit of U.S. Provisional Application No. 61/989,131 filed May 6, 2014, and incorporated herein by reference in its entirety.

### BACKGROUND OF THE INVENTION

Aspects of the invention described herein relate to a system and. a method for removing disinfectant solution from the teats or udder of a cow, or both, prior to or after a milking procedure.

A method of cleaning and disinfecting teats of cows prior to milking operations includes dipping the teats in teat dip cups that contain a disinfectant solution. These teat dip solutions typically include thickening agents such as emollients, conditioners, etc., so the disinfectant solution clings to the teats. This clinging allows the disinfectant solution to remain on the teats so the teats are disinfected and/or cleaned. Most prior art methods for drying or removing disinfectant solution from the udders and/or teats of cows include manually toweling off the udders and/or teats. Benefits of drying teats and udders include increasing the efficiency of the milking and cleaning process, and increasing the quality of the milk obtained from the cows which are dried, or from which disinfectant solution is removed prior to the milking procedure. However, manually drying teats as described above can be time consuming and inefficient.

A system and method for cleaning teats of milk producing is disclosed and taught in U.S. Pat. No. 8,402,920 (the '920 Patent), the content of which is incorporated herein in its entirety. The '920 Patent discloses the use of a hand-held applicator with scrubbing elements that are actuated as a disinfectant solution is supplied to a housing in which the scrubbing elements disposed. The hand-held applicator is in fluid communication with a disinfectant solution source to supply (via a pump and conduits) disinfectant solution to the housing of hand-held applicator as the scrubbing elements are actuated. The disinfectant solution is described as having a viscosity and/or vapor pressure substantially equal to that of water. There is further described a wash mode in which disinfectant solution is supplied to the housing as the scrubbing elements are actuated to clean and disinfectant teats. In addition, a dry mode is described during which disinfectant solution is not supplied to dry the teats.

In a rotary parlor that includes a rotating platform on which cows stand and are prepped for milking as the platform rotates, the platform may be rotating at a speed that does not allow a worker to execute a dry mode when using the above-described system and method of the '920 Patent, or a worker may not have time to towel dry the teats. In such cases, or in other methods that may not include the system and methods of the '920 Patent, the teats should not be allowed to drip dry, which may take too long. Milking preferably occurs within about 90 seconds of cleaning to take advantage of the stimulation of the teats caused by the scrubbing elements. Milk production is at a premium during this 90 second window, so one cannot afford to wait for the teats to drip dry. Moreover, if the cows are milked before the teats have fully dried this may result in dilution of the milk content acquired or contamination of the milk received during the milking process wherein the disinfectant solution used to clean the teats may be present in the milk. Furthermore, hand drying with a towel can be inefficient.

### BRIEF DESCRIPTION OF THE INVENTION

In one embodiment, a system is disclosed for removing disinfectant solution from one or more cows in a milking parlor, wherein the teats of the one or more cows have been cleaned and/or disinfected with a solution prior to a milking procedure. In an embodiment, the system may include a fluid flow generator having at least one fluid flow outlet. Embodiments of the system may comprise at least one nozzle including the at least one fluid flow outlet, wherein the at least one fluid flow outlet is in fluid communication with a conduit, which directs fluid flow from the fluid flow generator through the fluid flow outlet of the nozzle. Embodiments further comprise there being relative lateral movement between the teats and the at least one fluid flow outlet.

The terms “lateral movement” or “relative lateral movement” are intended to mean that the cows or the teats of the cows are moved laterally from one side to another side of the at least one fluid flow outlet that is stationary. The terms may also include side-to-side movement of the at least one fluid flow outlet as cows and/or teats are moving, for example, on a rotary parlor. These terms may also include movement (vertically, horizontally, or other orientations) of the fluid flow outlet as the cows and/or teats remain stationary. For example, the at least one fluid flow outlet may be moveable along a track to dry teats of cows.

Embodiments of the invention may comprise the fluid flow outlet being disposed at about 12 to about 30 inches from the rear teats of the cows. In embodiments, the at least one fluid flow outlet may have an oval or elliptical configuration, wherein the fluid flow outlet may have a vertical height dimension that is about 3 inches to about 4 inches, and preferably about 3.5 inches. In addition, the fluid flow outlet may have a horizontal width dimension of about 1.5 inches to about 2.0 inches, and is preferably about 1.75 inches. For such a configuration, the height dimension is the larger of the two dimensions regardless of the orientation (horizontal or vertical) of the at least fluid flow outlet. Embodiments may comprise a fluid flow across rear teats of a cow at a velocity of about 35 mph to about 80 mph, and preferably a fluid flow velocity of about 40 mph across the rear teats of a cow.

In a further embodiment, a method of cleaning and/or disinfecting teats of cows and for removing disinfectant solution from teats and/or udder of a cow is disclosed. The method may comprise applying a disinfectant solution to the teats of one or more cows. A further step may include, after application of the disinfectant solution to the teats of the one or more cows, supplying a fluid flow of air across the teats of the one or more cows from a fluid flow generator having at least one fluid flow outlet disposed toward the teats of the one or more cow. In addition, the method may comprise providing relative lateral movement between the teats of the one or more cows and the fluid flow outlet.

A method for cleaning and/or disinfecting teats of cows and for removing disinfectant solution from the teats and/or udder of a cow may also include positioning one or more teats of a cow in a housing of a hand-held applicator, and the housing includes one or more scrubbing elements that are actuated for scrubbing teats of a cow. The method may further comprise supplying a disinfectant solution to the housing as the scrubbing elements are actuated. The method further comprises, after the teats are removed from the housing, supplying a fluid flow across the teats of the cow as there is relative lateral movement between the teats and the fluid flow, and wherein disinfectant solution is removed from the teats and/or udder of the cow.

### BRIEF DESCRIPTION OF DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 provides a schematic view of an embodiment of a system for removing disinfectant solution from one or more cows in a parlor prior to a milking procedure.

FIGS. 2A-2E provide schematic illustrations of lateral movement between a fluid flow and a teat of a cow.

FIG. 3A provides a perspective front view of a nozzle with a vertically oriented fluid flow outlet.

FIG. 3B provides a perspective front view of a nozzle with a horizontally oriented fluid flow outlet.

FIG. 4A is a front view of an embodiment with nozzles and fluid flow outlets vertically aligned.

FIG. 4B is a front view of an embodiment with nozzles and fluid flow outlets arranged side-by-side and vertically offset relative to one another.

FIG. 4C is a front view an embodiment with nozzles and fluid flow outlets arranged side-by-side.

FIG. 5 is an embodiment of the system with the nozzle and fluid flow outlet disposed at an angle relative to an udder and teats of a cow.

FIG. 6 is a flow chart for a method for cleaning and/or disinfecting teats of a cow removing a disinfectant solution from teats or udders of cows.

FIG. 7 is a flow chart for a method for cleaning and/or disinfecting teats of a cow removing a disinfectant solution from teats or udders of cows.

### DETAILED DESCRIPTION OF THE INVENTION

For the purposes of promoting an understanding of the principles and operation of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to those skilled in the art to which the invention pertains.

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. As a non-limiting example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 7. It is to be noted that all ranges disclosed within this specification are inclusive and are independently combinable.

It has been discovered that drying or removing disinfectant solution from the teats of the cow after cleaning the teats and prior to a milking procedure is beneficial to the milking process. There are certain factors that must be considered; however, in a cow teat/udder drying or fluid removal system. One important factor is the effectiveness of the dryer to effectively and efficiently dry or remove disinfectant solution from the teats and/or udders. Another important factor includes the comfort level of the cow during the drying process.

In order to address at least the factors identified above, various details of the system and method for removing disinfectant solution must be considered including fluid (such as air) flow rate or velocity from a drying or disinfectant solution removal system to the cow, critical distance of a fluid flow outlet from the cow teats, size and shape of the nozzle used to remove disinfectant solution from the teats, texture and chemical composition of the disinfecting solution used to clean the teats prior to drying or removing disinfectant solution from the teats, angle of the fluid flow onto the teats of the cow, number of cows in a parlor, orientation of cows in the parlor, average width of the hocks of the cows, and height of the teats of the cows in the parlor.

The system embodiments disclosed herein for removing disinfectant solution from the teats of cows can be used in any type of milking parlor, but one specific example of a type of parlor in which they can be particularly beneficial is in a Rotolactor (i.e., rotary milking parlor). In such parlors, there is relative movement between the cows' udders and a fluid flow outlet. More specifically, the cows and their udders move relative to a stationary fluid flow outlet. However, parlors may be configured so that the fluid flow outlet moves relative to stationary cows, or both the cows and fluid flow outlet move relative to one another. Alternatively, the system embodiments described herein may also be beneficial in a non-rotary milking parlor wherein the cows are lined up next to one another, for example, and there is relative lateral movement between the system and the cows in a generally linear pathway.

The system, as will be described in more detail below, includes a fluid or air flow generator including a nozzle having a fluid flow outlet. The nozzle is in fluid communication with a conduit, and the conduit directs a fluid flow from the fluid or air flow generator through the fluid flow outlet, directed at one or more teats of a cow. The system may be positioned such that the nozzle is positioned behind the hind legs of the cow. The components of the system may be held together in one housing or may be associated with one another and connected via conduits and/or electrical connections to provide fluid communication there between, wherein in a non-limiting example, a housing includes the fluid or air flow generator and a conduit connects between the fluid or air flow generator and a nozzle which is movable about the housing. The system and/or the nozzle are provided to move relative to cows in a parlor, in one example. in an alternative example, the cows in the parlor move relative to the system and/or the nozzle.

While some embodiments of the invention are shown with one nozzle directed at the teats, two or more nozzles may be provided to account for cows of varying heights. Additionally or alternatively, a single nozzle may have multiple fluid flow outlets. Younger cows generally tend to have teats disposed higher than older cows. The system may also account for cows of varying heights with varying levels of teats. Consequently, in some embodiments, multiple nozzles may be provided. Alternatively, or in addition, the nozzle(s) may articulate about a horizontal or a vertical axis to provide greater coverage of fluid flow to the teats of the cow(s) and to accommodate for multiple cows with varying teat sizes and heights.

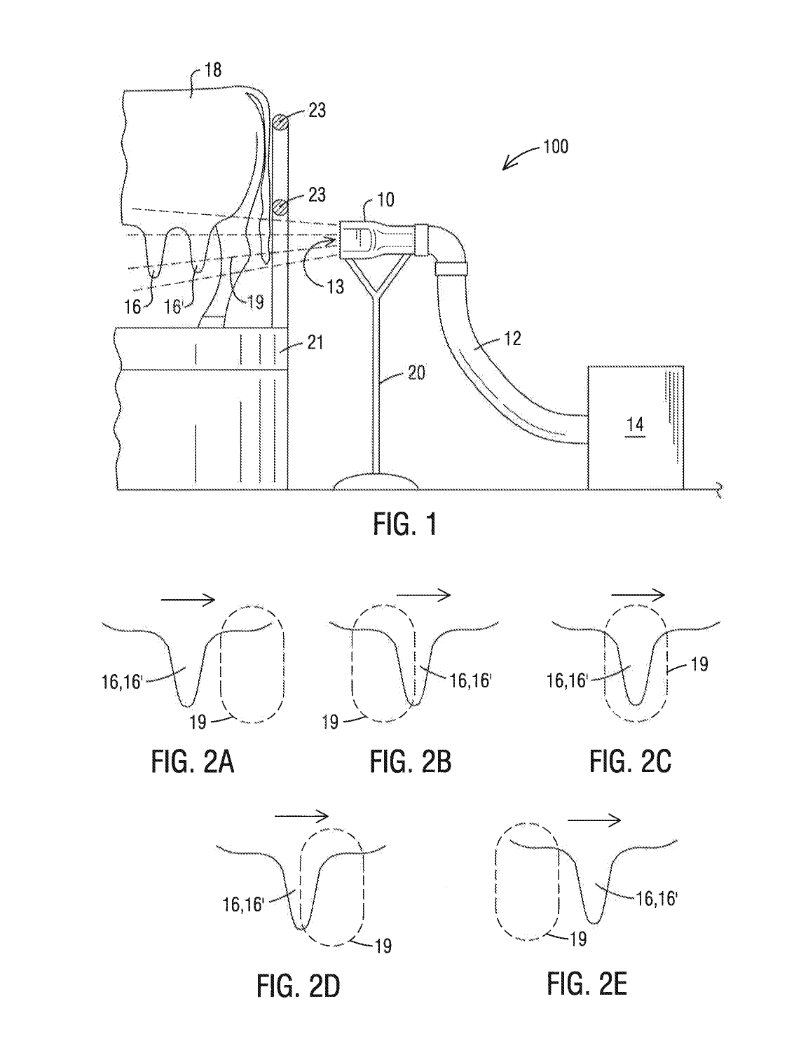

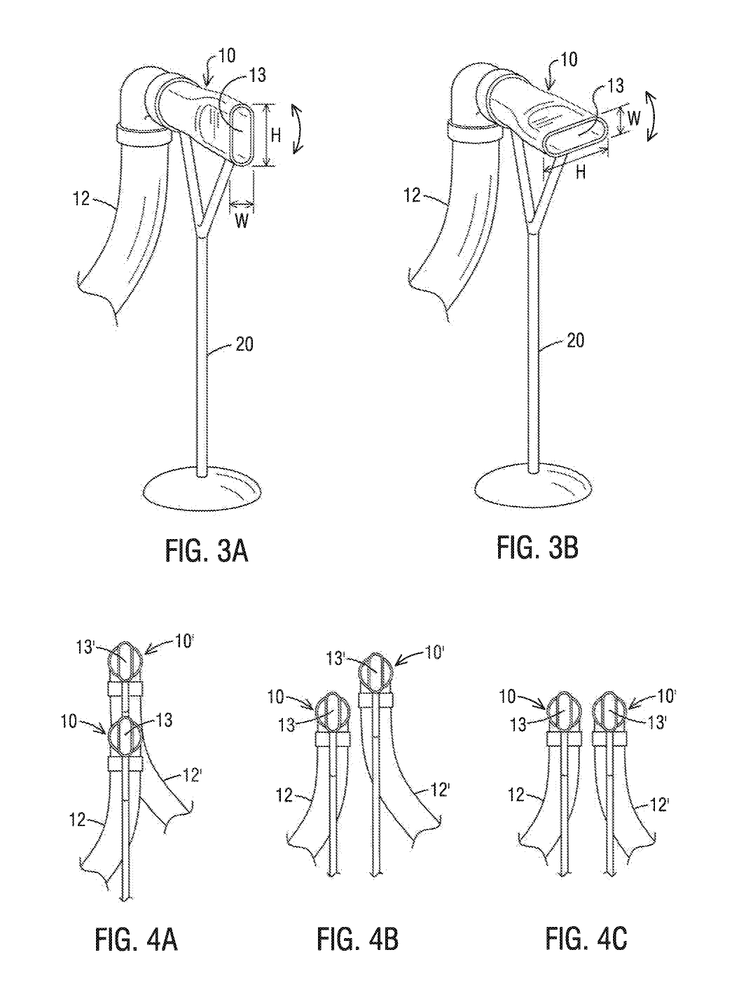

As illustrated in the drawing of FIG. 1, an embodiment of the system 100 is provided, wherein a fluid flow generator 14 includes a nozzle 10 and the nozzle 10 is connected to a conduit 12. The nozzle 10 has a fluid flow outlet 13 through which fluid flow is projected from the nozzle 10. The fluid or air flow generator 14 may be disposed within a housing which may provide a fluid flow or fluid stream 19 through the nozzle 10 and out through the fluid flow outlet 13. The nozzle 10 may be a vertically oriented nozzle (as shown in FIG. 1 and FIG. 3A) described below) or, alternatively, a horizontally oriented nozzle 10 (as shown in FIB. 3B) in other embodiments.

A vertically oriented nozzle 10 has its greatest diameter dimension or a height dimension H at the fluid flow outlet 13 of the nozzle 10 oriented in a vertical direction, substantially parallel to a plane defined by teats 16, 16′. A horizontally oriented nozzle 10 has its largest diameter dimension FT of its fluid flow outlet 13 oriented horizontally or substantially perpendicular relative to a plane defined by teats 16, 16′. The nozzle 10 may be provided, in one embodiment, wherein the fluid flow outlet portion 13 and the fluid flow 19 have a cross-sectional configuration that corresponds to a shape of the teats 16, 16′ of the cow 18. In one particular embodiment, the fluid flow outlet 13 of the nozzle 10 has a width dimension W that is about 1.5 inches to about 2 inches, and preferably about 1.75 inches, and a height dimension H of about 3 inches to about 4 inches, and preferably 3.5 inches. The height and width dimensions H,W provide a particular dimension of fluid flow 19 to the teats 16, 16′ to provide optimal drying and/or disinfectant solution removal from the teats 16, 16′.

In another embodiment, at least a portion of a cross sectional area of fluid flow 19 from the nozzle 10 and fluid flow outlet 13 may generally correspond to the length of the front or back teats 16 16′, respectively, of the cow. The term “generally corresponding” as used herein relative to a length of a teat 16, 16′ providing a cross-sectional area of fluid flow 19 that covers most if not all the teat from the tip of a teat to its base at the udder, and the fluid flow 19 cross-sectional area may cover or encompass portions of the udder, as shown in FIGS. 1 and 2. To that end, as shown in FIGS. 2A-E, a cross-sectional area of fluid flow 19 is shown generally corresponding to a length and/or shape of a teat 16, 16′. With respect to FIGS. 2A-2E, lateral movement between the teats 16, 16′ is shown to illustrate, the corresponding configurations of the fluid flow 19 and the shape of the teats 16, 16′.

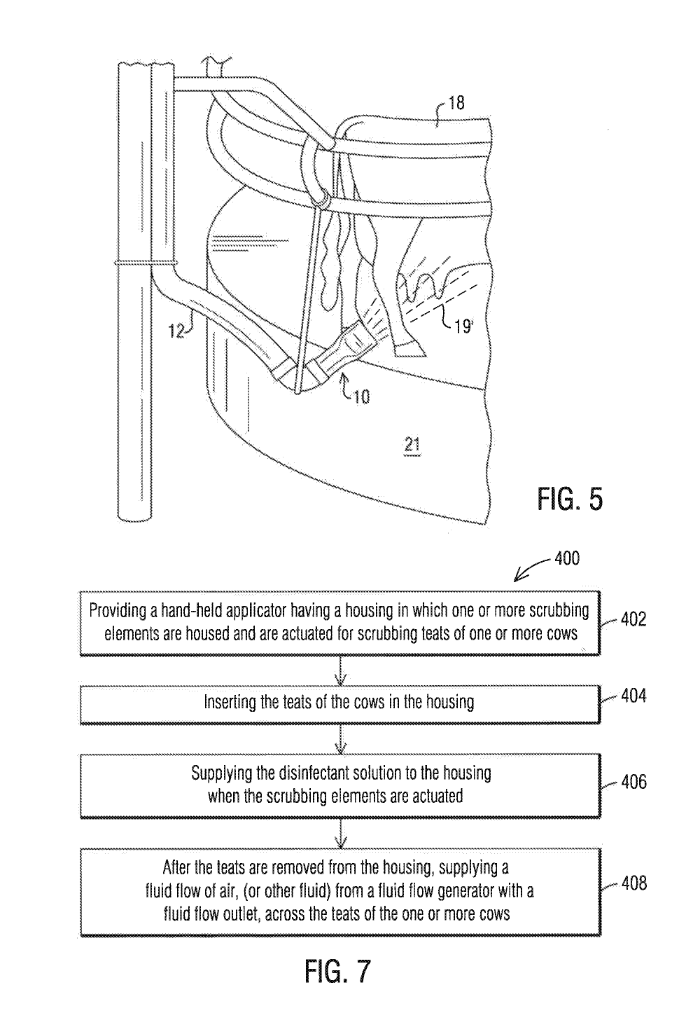

With respect to FIGS. 3A and 3B, the nozzle 10 may direct fluid flow at teats 16, 16′ of a cow, wherein the fluid flow outlet 13 of the nozzle 10 may be rotated or pivoted at different angle, such as a 45 degree angle, relative to a vertical longitudinal axis of the teats 16, 16′, in one non-limiting embodiment, such that at least a portion of a cross-sectional area of fluid flow is provided to “flick off” fluid from the teats 16, 16′ as the fluid flow from the system 100 contacts the teats 16, 16′. The fluid flow may be directed at the teats 16, 16′ at different varying angles (FIG. 5), in other embodiments, to achieve the “flick off” effect. The nozzle 10 is shown as disposed near the upper portion of the teats 16, 16′ at the udder 18 of the cow in FIG. 1; however, the nozzle 10 may be disposed at any level of the cow teats 16, 16′ including, but not limited to, below the teats 16, 16′ of the cow, wherein the fluid flow outlet 13 of the nozzle 10 can be angled in an upward direction to effectively dry or remove disinfectant solution from the teats 16, 16′ in other embodiments. The nozzle 10 may optionally be provided on a stand 20 as shown in FIGS. 3A and 3B. The stand 20 or nozzle 10 may be rotatable about a vertical axis, in one non-limiting embodiment. The stand 12 may accommodate different heights of cow teats 16, 16′, and may be vertically adjustable, in another non-limiting embodiment.

A distance between the distal portion of the rear teats 16′ and the fluid flow outlet 13 of the nozzle 10 can vary from about 12 inches to about 30 inches; however, in the embodiment of the system 100 shown in FIG. 1 it may be a distance of about 28 inches. As identified by the inventors herein, this distance is particularly beneficial for achieving optimal disinfectant solution removal results of the teats 16, 16′, in a non-limiting example. One of ordinary skill in the art would realize that other ranges of distances between the fluid flow outlet 13 and the cow teats 16, 16′ not specifically enumerated herein are contemplated herein.

The nozzle 10 as shown in FIGS. 1 and 3A is a vertically oriented nozzle 10 with a fluid flow outlet 13 directing the flow of fluid toward the teats 16, 16′ of the cow(s). As aforementioned, in one non-limiting embodiment, the fluid flow outlet 13 may have a width. dimension W that is about 1.5 inches to about 2 inches, and preferably 1.75 inches. The fluid flow outlet 13 may have a height dimension H that is about 3 inches to about 4 inches and is preferably about 4 inches

The fluid flow outlet 13 of the nozzle 10 may be rotated such that it is positioned at a slight angle relative to the cow teats 16, 16′. In one particular embodiment, the nozzle 10 may be positioned such that it is rotated to different angles, such as approximately a 45 degree angle, relative to a vertical longitudinal axis of the teats 16, 16′ such that the fluid flows from the fluid flow outlet 13 at generally a 45 degree angle toward the teats 16, 16′. The nozzle 10 may be provided such that it articulates about a vertical to provide further drying or disinfectant solution removal from the teats 16, 16′. In an alternative, embodiment shown in FIG. 3B, the nozzle 10 and fluid flow outlet 13 are disposed horizontally. In either of these embodiments, the stand 20 or nozzle 10 may be operatively connected to motion control devices to pivot about a vertical or horizontal axis.

When the nozzle 10 is provided as a horizontally oriented nozzle 10, in an alternative embodiment, the fluid flow outlet portion 13 of the nozzle 10 may advantageously be angled toward the teats 16, 16′ (see FIG. 5) so as to effectively move the fluid on the teats 16, 16′ from one end to the other (i.e., from an uppermost portion of the teat 16, 16′ to a lowermost portion of the teat 16, 16′ or vice versa to achieve the “flick off” effect). In an embodiment of the system 100, the nozzle 10 is angled so as to provide a fluid flow toward the teats 16, 16′ (or at least a portion of a cross sectional area of the fluid flow) at generally a 45 degree angle relative to the vertical longitudinal axis of the teats 16, 16′, for example. As aforementioned, the nozzle 10 could be positioned at a height below the teats 16, 16′ and could be oriented so as to be angled in an upward direction such that the fluid flow projects from the nozzle 10 to dry or remove disinfectant solution from the teats 16, 16′. The horizontally oriented nozzle 10 may advantageously be provided to articulate about a horizontal axis to further assist in drying or removing a disinfectant solution from the teats 16, 16′ in some non-limiting embodiments.

As shown in FIG. 2, embodiments of the system 100 include relative lateral movement between the teats 16, 16′ and the fluid flow outlet 13. If the system 100 is used in a Rotolactor, the system 100 or at least a portion thereof may be outside the circumference of the Rotolactor and the cows may be rotated about the circumference of the Rotolactor on a rotatable platform 21 as shown in FIGS. 1 and 5, for example. Alternatively, the cows may be stationary and the system 100, or at least a portion thereof, may move relative to the cows. In a further embodiment, the platform holding the cows around the circular parlor and the system 100 or a portion thereof may each rotate relative to one another. In an alternative embodiment, the cows may be positioned side by side and the cows and/or the system 100 may move in a generally linear direction relative to one another. For example, a track system may be provided wherein the nozzle 10 is operatively connected to the track and motion control devices to facilitate movement of the nozzle 10 as the cows 18 an teats 16, 16′ are stationary.

The term “stationary” as used to relative lateral movement means that that the position(s) cows or fluid flow outlet is moving, but the fluid flow outlet may be configured to articulate vertically or horizontally (move laterally) while remaining in the same location relative to a moving platform.

In FIGS. 1 and 3A, a front view of a portion of an embodiment of the system 100 is provided. A fluid flow generator (not shown in FIG. 3A) having a nozzle 10, wherein the nozzle 10 is vertically oriented such that the largest diameter or height of the fluid flow outlet 13 defines a plane that is oriented substantially parallel to the teats 16, 16′. The fluid flow outlet 13 is provided with a height dimension that is about 3.75 inches, in a non-limiting embodiment. Nozzles with varying diameters or heights can be used, including 3-inch nozzles or 5-inch nozzles in non-limiting embodiments. The velocity of fluid flow 19 at the rear teats 16′may vary according to such parameters as the size of the fluid flow outlet 13 and the distance the fluid flow outlet 13 is positioned from the rear teats 16′.

The nozzle 10 and fluid flow outlet 13 could be positioned at bars 23 on the platform 21, in which case the nozzle 10 and fluid flow outlet may be spaced anywhere from about 10 inches to about 14 inches from the rear teats 16′. However, such spacing is typically not practical because of milking equipment on the platform 21, which may be a rotary platform. Then inventors have found that an air flow velocity of about 40 mph at or across the rear teats 16′ is sufficient to dry the teats 16, 16′ prior to milking operations; however, the invention is not so limited and the velocity of the fluid flow 19 at or across the rear teats 16′ may range from about 35 mph to about 80 mph. An example of a fluid flow generator that may be used to generate air flow to remove disinfectant solution from teats and udders of cows is a pressure blower with centrifugal fans. Such a pressure blower is sold by Chicago Blower Corporation, Design 38 Cast Aluminum Pressure Blower, and may have a maximum volume flow rate of 700 CFM.

The fluid flow outlet 13 may be spaced from the rear teats from about 12 inches to about 30 inches, and the fluid flow 19 velocities may be adjusted by adjusting the volume flow rate of the generator 14. The term fluid flow “velocity” as used herein may be the velocity of the fluid flow at the rear teats of a cow, and it may include an average velocity of the cross-sectional area of the fluid flow or velocity at any one point within the cross-sectional area of the fluid flow at the rear teats 16′ of the cow.

FIGS. 4A-4C provide illustrations of embodiments of the system 100 having multiple nozzles 10, 10′. With respect to FIG. 3A, the first and second nozzles 10, 10′ may be vertically aligned with one nozzle 10′ positioned directly above the other nozzle 10 in another non-limiting embodiment. In FIG. 4B, the first and second nozzles 10, 10′ may be provided adjacent to one another and may also be disposed at varying heights (or vertically offset relative to one another) wherein the fluid flow from the fluid flow outlets 13, 13′ of each of the first and second nozzles 10, 10′ may overlap so as to reach teats 16, 16′ of cows of varying heights within one parlor, for example. In the embodiment of FIG. 4C, the nozzles 10, 10′ are positioned side-by-side in a manner such that the fluid flow 19 of each may overlap to dry teats; however, the nozzles 10, 10′ may be spaced apart so there is now overlap of fluid flow 19, so that teats of cows may be subjected to multiple fluid flows at spaced intervals to dry teats 16, 16′. In the embodiments of FIGS. 4A-4C, one or more fluid flow generators 14 may be used to generate air fluid flow across teats 16, 16′.

There may be more than two nozzles provided in other embodiments. The nozzles 10, 10′ may articulate (i.e., rotate about a vertical or horizontal axis) and may also be vertically and/or horizontally adjustable in non-limiting embodiments.

The above described system may be used in combination with a system and method for cleaning or disinfecting teats of milk producing animals as disclosed in the '920 Patent, the content of which is incorporated herein in its entirety. The '920 Patent discloses the use of a hand-held applicator with scrubbing elements that are actuated as a disinfectant solution is supplied to a housing in which the scrubbing elements are disposed. The hand-held applicator is in fluid communication with a disinfectant solution source to supply disinfectant solution to the hand-held applicator as the scrubbing elements are actuated. The disinfectant solution is described as having a viscosity and/or vapor pressure substantially equal to that of water.

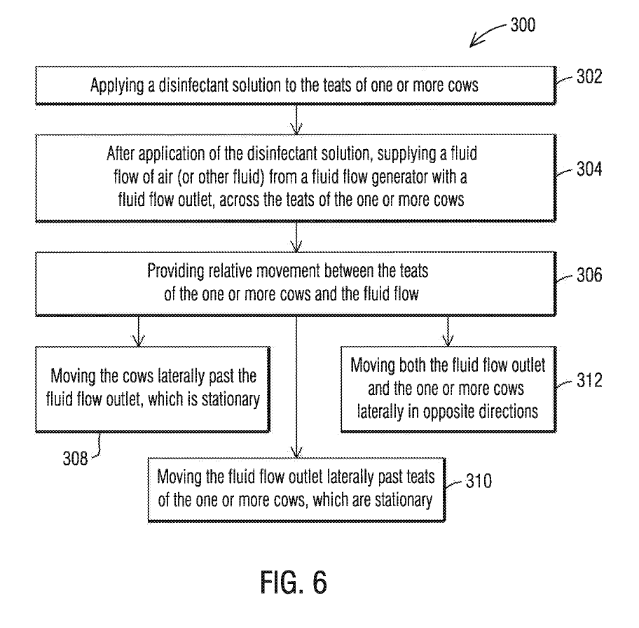

In a further embodiment shown in FIG. 6 there is described a method 300 for cleaning/disinfecting teats of a cow and removing disinfectant solution from the teats of a cow. As shown, the method 300 may include the step of first applying a disinfectant solution to the teats of one or more cows. The disinfectant solution may or may not have a viscosity and/or vapor pressure equal to that of water. After application of the disinfectant solution, step 302 includes supplying a fluid flow of air (or other fluid) across the teats of the one or more cows.

In addition, step 304 includes the step of providing lateral movement between the teats of the one or more cows and the fluid flow. This relative lateral movement is further set forth in steps 306, 308 and 310. More specifically, in step 306 the lateral movement may include moving the one or more cows with teats laterally past a stationary fluid flow outlet. In step 308, the lateral movement may include moving the fluid flow outlet past the one or more cows with teats, which are stationary. In step 310, the lateral movement may include moving both the fluid flow outlet and cows laterally in opposite directions.

The method 300 may be used with various types of cleaning/disinfecting systems and methods, which may include different or various types of disinfecting solutions, which may or may not have a viscosity and/or vapor pressure equal to that of water.

An embodiment of the method 300 is also described in FIG. 7 in reference to a method 400 of cleaning/disinfecting teats of one or more cows and removing the disinfectant solution from the teats of the one or more cows. The method 400 may include step 402 of providing a hand-held applicator having a housing in which one or more scrubbing elements are housed and are actuated for scrubbing teats of a plurality of cows, and the housing is in fluid communication with a disinfectant solution source including a disinfectant solution. The method 400 may comprise the step 404 of inserting the teats of the cows in the housing. In step 404, disinfectant solution is supplied to the housing when the scrubbing elements are actuated to clean and/or disinfect the teats of the cows, wherein said disinfectant solution has a viscosity and/or vapor pressure that is substantially equal to that of water. In step 406, after the teats are removed from the housing, a fluid flow of air is supplied across the teats of the cow from a fluid flow generator having at least one fluid flow outlet disposed toward the teats of the cows to remove disinfectant solution from the teats or dry the teats of the cows.

The above-described method 400 preferably includes step 304 and preferably one or more of steps 306, 308 and 310 regarding relative movement between the fluid flow outlet and the teats of the cows or one or more cows.

In the above-described methods 300, 400 or system 100, the fluid flow is preferably supplied continuously as the teats are moved laterally past the fluid flow outlet or vice versa, or if both are moving laterally relative to one another. More specifically, when cleaning teats of multiple cows in a parlor in preparation for milking procedures, the fluid flow generator 14 preferably remains activated to provide a. continuous flow of fluid, e.g. air, so as the cows and teats move past the fluid flow outlet 13 the teats are dried, and/or disinfectant solution from the teats 16, 16′, whether the cows 18 are moving, the fluid flow outlet 13 is moving or both the cows 18 and fluid flow outlet are moving. The fluid flow outlet 13 is positioned relative to the application stage of the disinfectant solution so that the disinfectant solution remains on the teats 16, 16′ a sufficient amount of time to clean and disinfectant the teats. In addition, the fluid flow outlet 13 is positioned in a manner so that teats 16, 16′ are dried and/or disinfectant solution is removed in time so that milking can begin within a time frame during which the teats 16, 16′ remain stimulated for milking.

While certain embodiments of the present invention have been shown and described herein., such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A system for removing disinfectant solution from teats of one or more cows prior to a milking procedure, comprising:
a fluid flow generator comprising at least one fluid flow outlet positioned relative to one or more cows to supply fluid flow across teats of the one or more cows after a disinfectant solution has been applied to the teats, and
wherein there is relative lateral movement between the teats and the at least one fluid flow outlet to remove disinfectant solution from the teats or dry the teats.

2. The system of claim 1, wherein the at least one fluid flow outlet of he first nozzle has a width dimension that is about 1.5 inches to about 2.0 inches.

3. The system of claim 1, wherein the at least one fluid flow outlet has a height dimension of about 3.0 inches to 4.0 inches.

4. The system of claim 1, wherein the at least one fluid flow outlet has a horizontal width dimension that is about 1.5 inches to about 2.0 inches, and a vertical height dimension that is about 3.0 to about 4.0 inches.

5. The system of claim 1, further comprising at least one nozzle having the at least one fluid flow outlet and at least one conduit providing fluid flow communication between the fluid flow generator and the at least one nozzle.

6. The system of claim 1, wherein at least one nozzle is configured to articulate about a vertical axis.

7. The system of claim 1, wherein the at least one nozzle is configured to articulate about a horizontal axis.

8. The system of claim 1, wherein a plurality of cows are on a rotary platform of a parlor and the at least one fluid flow outlet is stationary providing a continuous fluid flow from the at least one fluid flow outlet as the rotary platform rotates to move the teats of the cows laterally relative to the at least one fluid flow outlet to remove disinfectant solution from the teats or dry the teats of the cows.

9. The system of claim 1, wherein the at least one fluid flow outlet is configured to move laterally past a plurality of cows that remain stationary as a continuous fluid flow is supplied across the teats of the cows, which remain stationary as the fluid flow supply moves laterally relative to the cows and teats of the cows.

10. A system for removing disinfectant solution from teats of one or more cows prior to a milking procedure, comprising:
an fluid flow generator;
at least one nozzle in fluid communication with the fluid flow generator, and the at least one nozzle having at least one fluid flow outlet,
at least one conduit connecting the fluid flow generator to the at least one nozzle;
wherein the at least one nozzle is positioned relative to one or more cows in a parlor to supply a continuous flow of air over teats of the cows;
wherein there is relative lateral movement between the teats and the at least one fluid flow outlet so as to remove disinfectant solution from the teats or dry the teats of the one or more cows.

11. The system of claim 10, wherein the at least one fluid flow outlet of the at least one nozzle comprises a width dimension that is about 1.5 inches to about 2 inches.

12. The system of claim 10, wherein the at least one fluid flow outlet of the at least one nozzle comprises a height dimension that is about 3.0 inches to about 4.0 inches.

13. The system of claim 10, wherein a plurality of cows are on a rotary platform of a parlor and the at least one fluid flow outlet is stationary providing a continuous fluid flow from the at least one fluid flow outlet as the rotary platform rotates to move the teats of the cows laterally relative to the at least one fluid flow outlet to remove disinfectant solution from the teats or dry the teats of the cows.

14. The system of claim 11, wherein the at least one fluid flow outlet is configured to move laterally past a plurality of cows that remain stationary as a continuous fluid flow is supplied across the teats of the cows, which remain stationary as the fluid flow supply moves laterally relative to the cows and teats of the cows.

15. A method of cleaning and/or disinfecting teats of cows and for removing disinfectant solution from teats and/or udder of a cow, the method comprising:
applying a disinfectant solution to the teats of one or more cows;
after application of the disinfectant solution to the teats of the one or more cows, supplying a fluid flow of air across the teats of the one or more cows from a fluid flow generator having at least one fluid flow outlet disposed toward the teats of the one or more cows; and
providing relative movement between the teats of the one or more cows and the fluid flow outlet.

16. The method of claim 15, further comprising moving the cows laterally past the at least one fluid flow outlet.

17. The method of claim 15, further comprising moving the fluid flow outlet laterally past the teats of the cows.

18. The method of claim 15, wherein the fluid flow is provided continuously as there is lateral relative movement between the teats of the cows and the fluid flow.

19. The method of claim 15, wherein the disinfectant solution has a viscosity and/or vapor pressure substantially equal to that of water.

20. The method of claim 15, wherein the step of applying the disinfectant solution, comprises:
providing a hand-held applicator having a housing in which one or more scrubbing elements are housed and are actuated for scrubbing teats of a plurality of cows, and the housing is in fluid communication with a disinfectant solution source including a disinfectant solution;
inserting the teats of the cows in the housing; and
supplying the disinfectant solution to the housing when the scrubbing elements are actuated to clean and/or disinfect the teats of the cows.

21. The method of claim 15, wherein said disinfectant solution has a viscosity and/or vapor pressure that is substantially equal to that of water.
